(19) United States
(12) Patent Application Publication
(10) Pub. No.: US 2026/0275536 A1
(43) Pub. Date: Sep. 17, 2026

(54) REDOX MEDIATED GAS EVOLUTION

(71) Applicant: Schlumberger Technology Corporation, Sugar Land, TX (US)

(72) Inventor: Debora Campos de Faria, Cambridge (GB)

(21) Appl. No.: 19/561,611

(22) Filed: Mar. 10, 2026

(30) Foreign Application Priority Data
Mar. 12, 2025 (GB) 2503670.8

(51) Int. Cl. C25B 1/044; C25B 9/15

(52) U.S. Cl. CPC C25B 1/044; C25B 9/15

(57) ABSTRACT

An electrochemical system produces a gas from an aqueous solution. A liquid is circulated from a half-cell to a reaction vessel and then returned to the half-cell. A redox mediator in the liquid is converted from a first state to a second state in the half-cell and reacts to form a gas in the reaction chamber while being returned to its first state. The circulating liquid also includes a high molecular weight linear polymer or a viscoelastic surfactant which forms wormlike micelles enabling it to be in a state of elastic turbulence and the reaction chamber is configured to compel changes of flow direction so that the liquid is in a state of elastic turbulence as it flows through the reaction chamber. The half-cell may be configured such that the liquid is in a state of elastic turbulence as it flows through the half-cell.

### CROSS REFERENCE TO RELATED APPLICATIONS

This application claims priority to GB Patent Application No.: 2503670.8, which was filed on Mar. 12, 2025, and is incorporated herein by reference in its entirety.

### FIELD

This disclosure relates to electrochemical systems in which flow of electric current brings about the formation of a gaseous reaction product. One such system is the electrolytic splitting of water to form hydrogen and oxygen in gaseous form.

### BACKGROUND

It is conventional that electrolytic reaction to form a gaseous product takes place in an electrochemical half-cell. A gas or gases may be formed in either one or both half-cells of an electrochemical cell. An example in which gases are formed in both half-cells is the electrolytic splitting of water in which hydrogen gas is formed by electrochemical reaction in one half-cell and oxygen gas is formed by electrochemical reaction in the other half-cell. In a number of designs, the two half-cells are separated by a separator which prevents the mixing of the electrolyte liquids but allows passage of some ions to allow the overall chemical reaction to take place.

There are other electrochemical systems in which gas is produced. One of these is the chlor-alkali process in which one half-cell is supplied with a solution of a chloride salt, usually sodium chloride, and hydrogen is produced by the splitting of water and in the other half-cell chloride ions are converted to chlorine gas and the electrolyte liquid becomes alkaline.

Another possibility for electrochemical production of a gas is that a substance which is in solution in the electrolyte liquid of a half-cell, and which may be referred to as a redox mediator, undergoes an electrochemical reaction and is then transported from the half-cell to a reaction chamber where it undergoes chemical reaction at a catalyst leading to evolution of gas. This reaction returns the mediator to its original state, and it is circulated back to the half-cell. Arrangements using redox mediator(s) can produce gases, for instance hydrogen and oxygen, at positions which are spatially separated, making it simpler to prevent any mixing of the produced gases and improving their purity.

Redox mediators were initially proposed for use in flow batteries and a discussion concerning the redox potentials required for reaction in that context is provided by Moghaddam et. al., “Thermodynamics, Charge Transfer and Practical Considerations of Solid Boosters in Redox Flow Batteries”, Molecules 2021, Vol 26, 2111.

Arrangements using redox mediators for splitting water into hydrogen and oxygen have been constructed experimentally on small scale in laboratories and have been the subject of a number of scientific papers. An example is F. Zhang et al., “Decoupled Redox Catalytic Hydrogen Production with a Robust Electrolyte-Borne Electron and Proton Carrier”, J. Am. Chem. Soc., Vol 143, Pages 223-231, 2021

The potential required to bring about an electrochemical reaction normally consists of a thermodynamically determined potential, which is dependent on the reaction concerned, the material of the electrode and concentrations of reactants and products, plus an additional potential, referred to as overpotential. Overpotential reduces the efficiency of an electrochemical reaction. Overpotential may have a number of sources, but includes potential required for attracting reactive species from bulk solution to an electrode surface.

The efficiency of electrochemical systems can be quantified as a ratio of electric current to dimensions or weight of the apparatus. More specifically, current density, which is the ratio of electrical current to the area within an outline of the electrode is a measure of efficiency of an electrochemical half-cell. Electrodes are frequently formed of a porous or otherwise structured material to enhance the surface area within the electrode outline available for contact with liquid. A porous structure can also be used to support a catalyst. For example, the Supplementary Information to the above paper of F. Zhang et al. reports use of a catalyst comprising very small platinum catalyst particles carried on nickel hydroxide on nickel foam.

Designs which use a high surface area porous material can be classified as either “flow through” type in which there is an inlet to the porous material in one place and an outlet from it in another place or “flow-past” type in which the fluid flows across an outer surface of a body of porous material (which may be a thin body) and at least some of the fluid flow diffuses into the porous matrix. A flow-past design may have the advantage of a relatively low resistance to flow, with a largely even distribution of fluid when it is delivered to the porous electrode. However, this comes at the cost of relying on diffusive transport in the direction perpendicular to the channel, and within the porous electrode to facilitate the movement of electroactive species from the channel, to and from the electrode. Electrodes which are entirely flow-through or entirely flow-past represent extremes. There are many flow field designs which are in between.

When gas is formed from liquid in an electrochemical half-cell, the gas is initially in solution in the liquid. The liquid becomes supersaturated with the gas and bubbles begin to form on the solid surface where the gas is first formed. Interfacial tension causes the very small bubbles to adhere to the solid surface. Coalescence of adjacent bubbles makes the bubbles grow larger, but they remain on the surface until they reach a size at which their buoyancy overcomes the adhesion to the solid surface.

While the bubbles are adhering to the solid surface, they are masking an area of that surface, making this unavailable for the electrochemical reaction. This reduction of the available area reduces the amount of electric current which can flow. The overall current density is reduced. This is a well-known problem with the electrolytic manufacture of hydrogen and oxygen from water, as for instance discussed in Sweigers et al., “Sustainable Energy and Fuels”, Vol 5, Page 1280, 2021.

Use of a porous material as an electrode or as part of an electrode assembly may exacerbate this issue in that capillary effects (which arise from interfacial tension) in the small channels through a porous material can considerably impede the movement of gas bubbles, so that masking by bubbles and consequent reduction of surface area available for reaction becomes even more significant.

### SUMMARY

This summary is provided to introduce concepts that will be further elaborated and described below in the detailed description. This summary is not intended to be used as an aid in limiting the scope of the claimed subject matter.

The present disclosure uses the phenomenon of elastic turbulence. It is a physical phenomenon discovered at the end of the twentieth century. It occurs at low flow speeds where a Newtonian liquid such as water would be in a state of laminar flow.

The present disclosure uses the phenomenon of elastic turbulence in a reaction chamber where gas is produced by reaction of a redox mediator. In a first aspect the present disclosure provides a system comprising an electrochemical half-cell comprising an electrode, a reaction chamber, at least one pump, and connections between the pump, the vessel and the half-cell to provide a flow circuit for the pump to circulate a liquid through the reaction chamber, from the reaction chamber to the half-cell, through the half-cell and back to the reaction chamber; wherein: the half-cell defines a flow path to carry through flow of the liquid into contact with the electrode, the reaction chamber contains a structure which is, or which supports a reaction catalyst, and the reaction chamber defines a flow path to carry through flow of the liquid into contact with the catalyst, the liquid is able to undergo reaction at the catalyst to form a gas, an electrochemically reactive mediator substance is dissolved in the liquid, the mediator substance being able to undergo an electrochemical conversion between a first state and a second state at the electrode, wherein the mediator substance and the liquid are such that when electric current is supplied to the electrode while the pump is circulating the liquid, the mediator substance is converted from its first state to its second state at the electrode, reaction at the catalyst in the reaction chamber forms gas from the liquid and returns the mediator substance to its first state, and further wherein the liquid further contains a solute enabling the liquid to display elastic turbulence, and the flow path in the reaction chamber is configured to compel changes in the direction of liquid flow, to cause elastic turbulence within flow of the liquid in contact with the catalyst.

Elastic turbulence in a system where liquid circulating through a half-cell and a reaction chamber contains a redox mediator can have several benefits. The elastic turbulence can enhance the separation of gas bubbles from catalyst and catalyst support, enhancing efficiency. Improved mass transport of the redox mediator to the catalyst surface, as a result of the turbulent flow, may enhance reaction rate at the catalyst and provide more complete reaction of the redox mediator at the catalyst. Elastic turbulence requires much lower speed of flow than inertial turbulence and so the energy needed for pumping is less than with inertial turbulence. Moreover, elastic turbulence may be possible in circumstances where resistance to flow would make inertial turbulence unachievable. The lower speed of flow required by elastic turbulence may be helpful in giving longer residence times within the half-cell and reaction chamber.

The potential required to bring about reaction at the electrode is a thermodynamically determined potential plus any overpotential. The thermodynamically determined potential is dependent on the material of the electrode, the chemical species which react at the electrode, the product formed and the concentrations of the reacting species and the products. The thermodynamically determined potential E is given by the Nernst equation which, in a simplified form, can be written as:

$$E = {E}_{0} - \frac{RT {\sum }_{i} ln [ {P}_{i} ]}{zF {\sum }_{i} ln [ {S}_{i} ]}$$

where E₀ is a standard potential, [P] is the concentration of a product, [S] is the concentration of a starting reactant, R is the gas constant, Tis temperature, F is Faraday's constant and z is the number of electrons transferred in the reaction. Since redox potential is affected by concentrations of reactants and products it may be desirable that redox mediator is fully, or nearly fully, converted to its reactive second state as it passes through a half-cell and then is fully, or nearly fully, used and returned to its first state as it passes through the reaction chamber.

Consequently, the design of the apparatus, in particular size of a reaction chamber, the choice of redox mediator and its concentration in the liquid and choice of catalyst for gas formation may aim to achieve a rate of reaction such that as much as possible of the redox mediator is returned to its first state as it passes through the reaction chamber, and so minimize the amount of redox mediator which is still in its second state when the circulating flow carries it back to the half-cell.

It may also be desirable that the size of the electrochemical half-cell and the rate of the electrochemical reaction in the half-cell are such that a high proportion of the redox mediator is converted to its second state as it passes through the half-cell and so it may be arranged that flow through the half-cell is also in a state of elastic turbulence. However, it may be that electrochemical reaction of the redox mediator in the half-cell is sufficiently fast that elastic turbulence is used in the reaction chamber but is unnecessary in the half-cell. It is also possible that the system is designed to limit reaction of redox mediator to its second state as the liquid flow carries it through the half-cell in order that the amount of redox mediator entering the reaction chamber is not greater than the amount which can be converted back to its first state as it passes through the reaction chamber.

The electrochemical half-cell is, by definition, one half of an electrochemical cell in which each half has an electrode. The two half-cells may be separated by a separator restricting flow between the half-cells while allowing passage of ions which are required to move from one half-cell to the other. A separator may be a membrane which has selective permeability for anions or for cations.

One possibility is that one half-cell is connected with a reaction chamber and a pump as stated above, while the other half-cell is connected and operated in some other way. For instance, the second half-cell may carry out an electrochemical reaction without a circulating redox mediator, or the overall process may be such that redox mediator passing through the second half-cell takes part in a chemical reaction which will not produce a gas.

However, the second half-cell may be connected to a second reaction chamber and a second pump in a second flow circuit and a second liquid is circulated through the second half-cell and second reaction chamber, with a second gas produced by chemical reaction in the second reaction vessel. The second liquid may or may not contain a solute which enables elastic turbulence to occur in the second reaction chamber. The gases produced in the first and second reaction chambers may be oxygen and hydrogen.

### BRIEF DESCRIPTION OF THE DRAWINGS

Many of the drawings are diagrammatic and are intended to show the positions of component parts in relation to each other. Thin components such as membranes are shown with exaggerated thickness to make them and their positions more readily seen in these drawings.

FIG. 1 is a plot of experimental results showing onset of elastic turbulence.

FIG. 2 is a perspective view of a flow guide.

FIG. 3 is an enlarged top view of a portion of the flow guide.

FIG. 4 is a diagram of apparatus for observing elastic turbulence by means of birefringence.

FIG. 5 shows, in grayscale, pictures obtained with the apparatus of FIG. 4.

FIG. 6 is a slightly enlarged cross section of the flow chamber shown in FIG. 4, fitted with electrodes.

FIGS. 7A and 7B show pictures obtained with the apparatus of FIGS. 4 and 6.

FIG. 8 is a schematic diagram showing component parts of apparatus having an electrolytic cell, two reaction chambers and associated equipment for splitting water into hydrogen and oxygen.

FIG. 9 is a schematic diagram showing component parts of another electrolytic cell, two reaction chambers and associated equipment for splitting water into hydrogen and oxygen.

FIG. 10 is a top view of a portion of a flow guide, with pillars of a different shape to those in FIGS. 2 and 3.

FIGS. 11, 12 and 13 are schematic diagrams of electrochemical cells which may be used in apparatus as shown by FIG. 8 or FIG. 9.

FIG. 14 is a schematic diagram showing component parts of apparatus having an electrolytic cell, one reaction chamber and associated equipment for splitting water into hydrogen and oxygen.

FIG. 15 is a schematic diagram of an electrolytic cell which may be used in the apparatus of FIG. 14.

FIG. 16 is a diagrammatic view of apparatus to determine operating parameters for an electrochemical half-cell.

FIGS. 17 and 18 show experimental results obtained with one example of such apparatus.

### DETAILED DESCRIPTION

This detailed description shows various embodiments of the present disclosure and possibilities which may be used. It should be appreciated that features or possibilities described in combination may, where it is practical to do so, be used separately. Also, features or possibilities described in any embodiment may be used in any other embodiment, in so far as it is possible to do so.

The present disclosure uses the phenomenon of elastic turbulence. It is of course well known that Newtonian liquids such as pure water can undergo either laminar flow or turbulent flow. Such turbulent flow may be referred to as inertial turbulence. Conditions for laminar flow and inertial turbulent flow are often expressed by Reynolds number which is a ratio of inertial to viscous forces within a liquid. Reynolds number has no dimensions because it is a ratio. At Reynolds number above about 2000 there is inertial turbulent flow. At Reynolds number below about 1500, flow of a Newtonian liquid is laminar. Flow paths within porous materials often have small dimensions and rapid flow rates through such materials are not practical, with the consequence that it is not a practical possibility for flows through porous materials to undergo inertial turbulence.

Elastic turbulence is different from inertial turbulence. It is a physical phenomenon discovered at the end of the twentieth century. It has been observed at low flow speeds where Reynolds number is low, and a Newtonian liquid would be in a state of laminar flow. Some early observations of elastic turbulence used the older term “elastic instability”. However, that term is more general and includes other forms of instability in flow. Literature documents relating to elastic turbulence include a detailed discussion by Steinberg, V. (2021), “Elastic Turbulence: An Experimental View on Inertialess Random Flow”, Annual Review of Fluid Mechanics, 53, 27-58.

The phenomenon of elastic turbulence of a liquid requires: a solute which has elastic properties, enabling the liquid solution to display elastic turbulence; a flow path for the liquid which compels a succession of changes in its direction of flow, and pumping the liquid along the flow path at a sufficient velocity. A succession of changes in direction may be continuous curvature as in concentric or helical flow or may alternate between turning to the right and to the left.

Elastic turbulence occurs in solutions containing a solute which has a flexible structure. One category of material which is able to undergo elastic deformation and enable a solution to display elastic turbulence is a polymer containing long flexible linear chains. The number of monomer units in the polymer may be at least 5000 and may be considerably more such as at least 25,000. The monomer units may be present in linear chains of at least 1000 monomer units which may each be connected one to the next by a single covalent bond, so that one monomer unit can rotate relative to adjoining monomer units. Individual linear chains may be longer, and a polymer may contain a linear chain of at least 5000 or even at least 10,000 monomer units. A polymer chain may contain only one kind of monomer, or the chain may be a copolymer of more than one monomer, for instance a block copolymer which is linear. A polymer may also include side chains attached to a long chain of monomer units which are connected together by single covalent bonds. If a chain contains units which are themselves an oligomer, as in a block copolymer for instance, the oligomeric units may rotate relative to one another more freely than monomer residues within an oligomeric unit. A polymer may include some chain branching, for instance, at branch points where three or more linear chains, each of at least 1000 monomer units, are connected together. When using a long chain polymer to enable elastic turbulence to occur, it is desirable to include a biocide to protect the long chain linear polymer from biodegradation.

The flexibility of the polymer chains enables the polymer molecules to become entangled. The flexibility of polymer chains can be described by means of a mathematical model. The freely jointed chain model is commonly used, and the flexibility of a particular polymer can be indicated by parameters of an equivalent freely jointed chain (itself a mathematical model). A description of this approach is provided by Chapter 2 of “Polymer Physics” by Rubinstein and Colby, 2003, Oxford University Press. An equivalent freely jointed chain has the same mean-square end-to-end distance and the same maximum end-to-end distance as the actual polymer but is considered to consist of so-called Kuhn monomers which are freely rotatable relative to each other. These model monomers have a length, termed the Kuhn length, and a molar mass.

Polymers to enable elastic turbulence may contain at least one flexible polymer chain with length and composition represented by at least 5000 Kuhn monomers having a Kuhn length not more than 100 Angstroms (10 nm) and possibly not more than 50 Angstroms. If a polymer is a single unbranched chain, its length and composition may correspond to at least 20,000 Kuhn monomers and possibly at least 50,000 Kuhn monomers.

The mean molecular weight of the polymer may be at least one Mega Dalton i.e. at least 10° Daltons, possibly at least 10 Mega Daltons or more. The concentration of such long chain/high molecular weight polymer included in a solution for enabling elastic turbulence to occur may be under 5% by weight, for instance, in a range from 0.05% or 0.1% up to 1% or 2% by weight.

Elastic turbulence has been observed with several different long chain polymers in solution. One such polymer is polyacrylamide, which may be hydrolyzed or partially hydrolyzed. Experimental evidence for elastic turbulence in a solution of high molecular weight polyacrylamide was given by Groisman, A., Steinberg, V., “Elastic turbulence in a polymer solution flow”, Nature 405, 53-55 (2000). Other instances of long chain polymers reported to give rise to elastic turbulence include polyisobutylene of molecular weight 4 to 6 Megadaltons dissolved in an organic solvent (Dris and Shaqfeh, “Experimental and theoretical observations of elastic instabilities in eccentric cylinder flows: local versus global instability”, Journal of Non-Newtonian Fluid Mechanics, Vol 80, Pages 1 to 58 (1998)), polystyrene of molecular weight 18 Megadaltons in an organic solvent Magda and Larson, “A transition occurring in ideal elastic liquids during shear flow”, Journal of Non-Newtonian Fluid Mechanics, Vol 30, Pages 1-19 (1988)) and polyethylene oxide of molecular weight 4 MegaDaltons in an aqueous solution (Davoodi et al., “Secondary flows due to finite aspect ratio in inertialess viscoelastic Taylor-Couette flow”, Journal of Fluid Mechanics, Vol 857, pages 823-850 (2018)). Kuhn lengths for polystyrene and polyethylene oxide have been reported as 18 Angstroms and 11 Angstroms (Rubinstein and Colby (2003), “Polymer Physics”, Page 53). Kuhn length for polyacrylamides has been reported as 15 to 25 Angstroms (Fetters, Lohse and Colby, “Chain Dimensions and Entanglement Spacings” in Physical Properties of Polymers Handbook, Springer, 2007; pages 447-454).

Long chain partially hydrolyzed polyacrylamide linear polymers with a molecular weight of more than 1 MegaDalton are available from SNF Floerger, whose headquarters are in Andrézieux, France.

Another category of material able to undergo elastic deformation and enable a solution to display elastic turbulence is a viscoelastic surfactant which forms worm-like micelles in solution. There is extensive scientific literature concerning surfactants which form worm-like micelles, their properties and applications. One review is Yang “Viscoelastic wormlike micelles and their applications” Current Opinion in Colloid & Interface Science, Volume 7, pages 276-281 (2002). Discussions of properties include Raghavan and Kaler “Highly Viscoelastic Wormlike Micellar Solutions Formed by Cationic Surfactants with Long Unsaturated Tails” Langmuir, Vol 17, Pages 300-306 (2001) and Beaumont et al, “Turbulent flows in highly elastic wormlike micelles”, Soft Matter, Volume 9, Page 735-749 (2013). An example, using cetyl trimethyl bromide as the surfactant, is mentioned by Fardin et al., “Elastic Turbulence in Shear Banding Wormlike Micelles” Physical Review Letters, 104, 178303 (2010).

When a solution contains a substance able to cause elastic turbulence, the phenomenon of elastic turbulence occurs if the solution is flowing at a sufficient flow velocity (which may be a low velocity) and the path of flow causes the streamlines of the flow to curve. Consequently, one known possibility for a flow path which induces elastic turbulence is a serpentine channel. Another possibility is a flow path with obstructions which compel the streamlines of flow to change direction. Such obstructions may be manufactured and arranged in a pattern so as to compel flow around the obstructions to change direction.

A porous material can also provide a flow path which causes a succession of changes of direction. Changes in the directions of pores and connections between pores can compel changes of flow direction. A porous material may be fibrous and the openings between the fibers will provide flow paths with a succession of changes of direction.

The ability of a fluid composition to display elastic turbulence can be shown experimentally using a laboratory rheometer. In a cone and plate rheometer cell, the onset of elastic instability with application of increasing shear is observed as an apparent increase in viscosity at a particular shear rate associated with an abrupt increase in the noise in the measured torque signal. This has been described by D. O. Olagunju, “Instabilities and bifurcations of von Karman similarity solutions in swirling viscoelastic flow” in Z Angew Math Phys, 46 (1995) 224-238 and also by E. Tran, A. Clarke, “The relaxation time of entangled HPAM solutions in flow”, Journal of Non-Newtonian Fluid Mechanics, 311 (2023) 104954. The apparent increase in viscosity can be seen as a change in the slope (sometimes referred to as an uptick) in the plot of viscosity against shear rate.

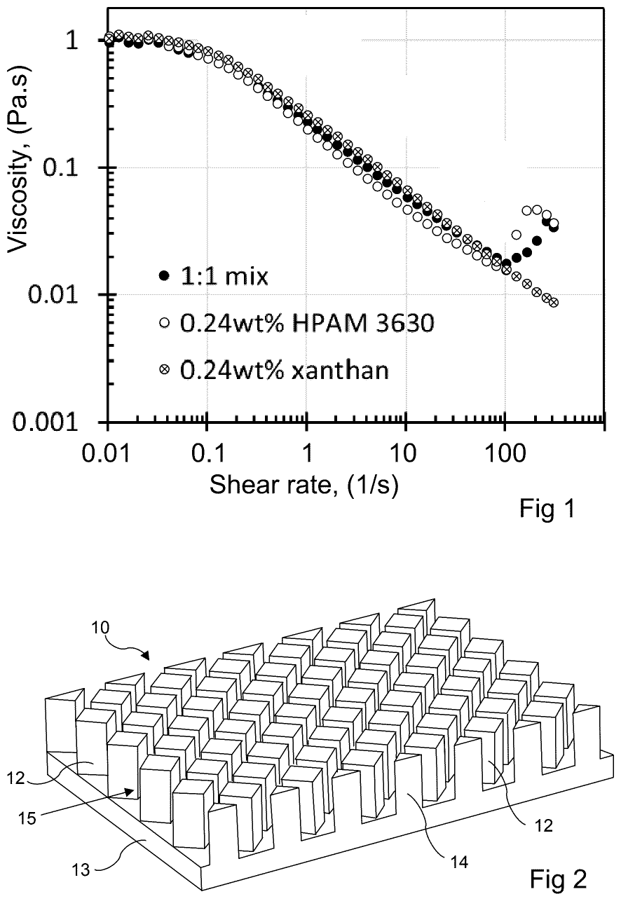

FIG. 1 shows results from experimental tests carried out with a laboratory rheometer operated to take measurements at increasing steps in shear rate and then at decreasing steps. It is a plot of dynamic viscosity against increasing shear rate for three aqueous solutions containing 0.456 wt % sodium chloride, a small percentage of a polymer and a few drops of a biocide consisting of isopropanol and thiourea. In one of these aqueous solutions (points shown as open circles in FIG. 1) the polymer was 0.24 wt % of Flopaam 3630 from SNF Floerger which is linear polyacrylamide with a mean molecular weight of 18 to 20 MegaDaltons. In a second of these solutions (points shown as circles containing a cross) the polymer was 0.24 wt % xanthan. In the third of these solutions (points shown as filled circles) the polymer was 0.12 wt % Flopaam 3060 and 0.12 wt % xanthan, i.e. a 1:1 mix. The solutions containing polyacrylamide, either alone or in mixture with xanthan, showed change in slope of the plotted curve, seen at approximately 150 s⁻¹. This indicated the onset of elastic turbulence with increasing shear rate. The solution containing xanthan had no such change of slope, indicating that this more rigid polymer did not enable elastic turbulence to occur.

A similar experiment used a solution containing 0.2 wt % of Flopaam 6040, also from SNF Floerger, with a mean molecular weight between 25 and 30 MegaDaltons. Here too the onset of elastic turbulence with increasing shear rate was seen as a change in slope of the plotted curve at approximately 150 s″ indicating the onset of elastic turbulence. (Shear rates for the onset of elastic turbulence in electrochemical half-cells may be lower).

FIGS. 2 to 6 relate to experimental demonstrations of elastic turbulence in aqueous solutions of viscoelastic surfactant and also in aqueous solutions of a flexible polymer.

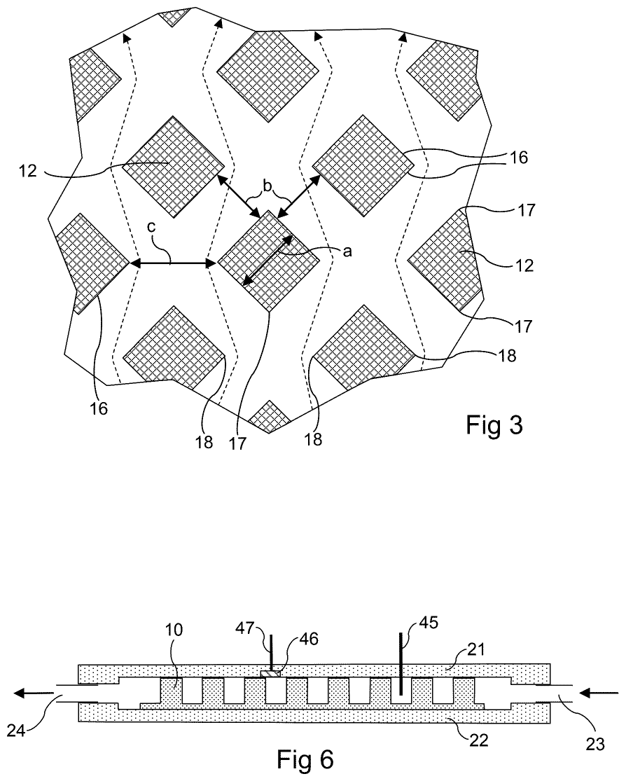

FIG. 2 shows a flow guide 10 used in these experiments. It has a regularly spaced array of pillars 12 of square cross section integral with a base 13. Two edges of the array are completed with pillars 14 which have a triangular cross section. FIG. 3 is an enlarged top view of a portion of the flow guide. As shown, the pillars 12 each have a square cross section with flat faces 16 meeting at corner edges 17 and 18. The width of a flat face 16 is indicated as “a” in FIG. 3 and the spacing between the faces 16 of adjacent pillars is indicated as “b”. The width of the gap between two confronting edges 18 is of course given by Pythagoras theorem as √(2b²). Each pillar 12 is positioned so that the diagonal across the square cross section between corner edges 17 is aligned with the overall direction of flow. As indicated by broken lines, liquid flows through the gaps between confronting edges 18 of adjacent pillars 12 but is then compelled to turn by pillars downstream. Thus, the array of pillars 12 obstructs straight line through flow of liquid, causing the streamlines of the flow to change direction repeatedly.

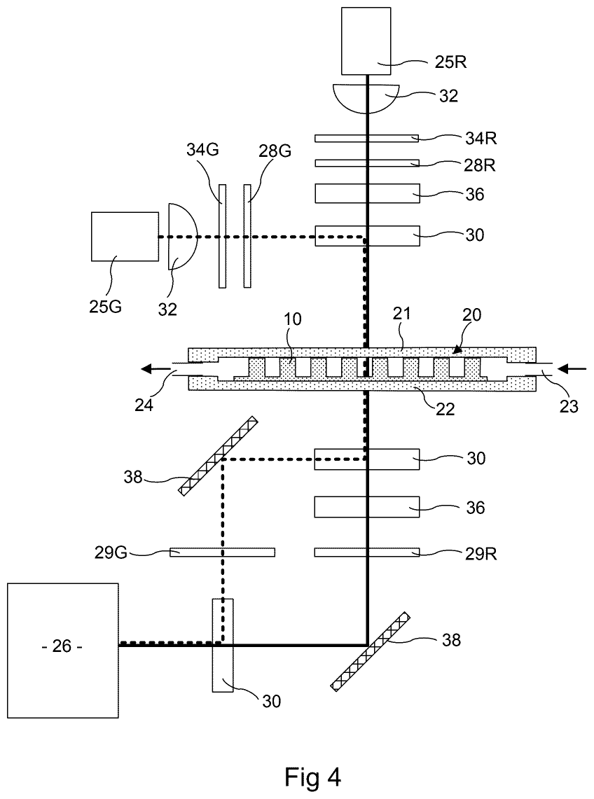

The flow guide 10 is made of transparent polymer and is located within a chamber 20 which is shown in cross section in FIG. 4. The chamber 20 is formed by two blocks of transparent polymer, 21, 22 held together by bolts which are not shown. The flow guide 10 is in a cavity between the two blocks. There is a liquid inlet 23 to the cavity and a liquid outlet 24. When liquid is pumped through the chamber 20, the liquid enters the flow guide 10 at the end indicated 15 in FIG. 2 and then flows through the gaps between the pillars 12. The repeated changes in direction can cause elastic turbulence to occur, if the liquid contains a substance able to display elastic turbulence and the flow velocity is sufficient.

The occurrence of elastic turbulence was observed using a technique utilizing the phenomenon of birefringence. The apparatus is shown in FIG. 4. It has some similarity to apparatus described by Moss GR and Rothstein JP in “Flow of wormlike micelle solutions through a periodic array of cylinders”, Journal of Non-Newtonian Fluid Mechanics, Vol 165, Pages 1-13, 2010.

Beams from a red LED light 25R and a green LED light 25G are directed along paths, respectively shown as a solid line and as a broken line, towards a video camera 26. The chamber 20 is positioned between linear polarizing filters 28R, 29R set with their polarization directions at right angles (i.e., crossed) and between linear polarizing filters 28G, 29G which are also set with their polarization directions at right angles to each other. Consequently, no light can reach the video camera 26 unless birefringence in the chamber 20 alters the angle of polarization of light as it passes through the chamber. The filters 28R and 28G are set with their polarization directions at right angles to each other, so that the planes of polarization of the red and green light entering the chamber 16 are at right angles to each other. Dichroic mirrors 30 which pass the red beam and reflect the green beam are used to merge the red and green beams, then to separate them after they have passed through chamber 20, and subsequently to reunite them before they arrive at the camera 26.

Other parts of the apparatus are mirrors 38, lenses 32, red and green bandpass filters 34G and 34R and dichroic mirrors 36 which are set with a 90° difference in rotation with respect to the red beam path in order to cancel rotation of polarization induced due to Fresnel refraction. Such dichroic mirrors were not needed for the green beam because its polarization is such that no rotation of polarization was induced.

Wormlike micelles formed by viscoelastic surfactants are birefringent. Consequently, when these molecules become aligned by liquid flow within the chamber 20 and are illuminated with polarized red and green light, they can change the plane of polarization of the light thereby allowing some of this light to pass through the filters 29R and 29G to the camera, although this will not occur if the alignment of the micelles coincides with the plane of polarization of the light. Providing two light beams with different planes of polarization as they enter the chamber 20 addresses this issue: if micelles happen to be aligned with the red polarization, they will not be aligned with the green polarization and vice versa. Hence the apparatus is sensitive to polarization alignment in any direction.

When there is flow of a liquid containing wormlike micelles through the chamber, these micelles become aligned through extensional flow as the liquid flows around the pillars 12, 14 of the flow guide 10, and the birefringence from the aligned micelles can be seen as red or green color in pictures or video recorded by the camera 26.

A first experiment was carried out using a solution similar to one mentioned by Moss and Rothstein in the paper above. This solution contained 100 mM (approx. 4 wt %) of the viscoelastic cationic surfactant cetylpyridinium chloride and 50 mM (approx. 0.8 wt %) of sodium salicylate dissolved in a brine of 100 mM (approx. 0.6 wt %) sodium chloride in distilled water.

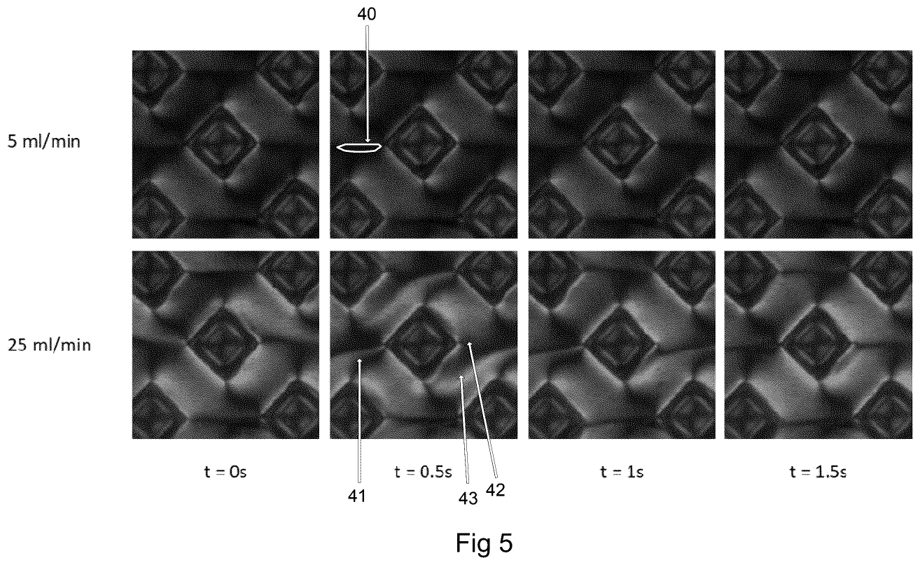

The viscoelastic solution was pumped through the chamber 20 at a low flow rate of 5 ml per minute. The camera 26 recorded video at twenty frames per second for a period of 5 seconds and the recording showed that the pattern of flow around the pillars of the flow guide remained constant. Four pictures from that video recording, at half second intervals, are shown in grayscale as the top row in FIG. 5 and it can be seen that there is negligible change from one picture to the next. The original-colored pictures showed a line of red color extending in the flow direction from the downstream corner of each pillar. A white outline has been drawn around one of these indicated 40 in one picture. These lines of red color remained at the same intensity and in the same position throughout the video recording. The flow rate was then increased to 25 ml/min and video was again recorded for 5 seconds. This video recording of flow at 25 ml/min was very different from that at 5 ml/min. It showed constant movement. Patches of color, which is where extensional flow was aligning micelles, were moving from one position to another and varying in intensity. Four pictures from the video with 25 ml/min flow rate are reproduced in grayscale as the bottom row of FIG. 5. There are a number of changes from each picture to the next. For instance, arrow 41 points to a patch of red color which was present in one picture but absent from the preceding picture and diminished in the two subsequent pictures. At the position 42 there was an area of red color which was not present in the preceding picture and again diminished in the next two pictures. The second picture in the lower row also shows an intense green area 43, which was not present in the first picture, and which largely disappeared in the third picture. Thus, it could be seen that flow at 5 ml/min was laminar but at 25 ml/min the flow had become turbulent.

Similar experiments were carried out with a solution containing partially hydrolyzed polyacrylamide of average molecular weight 18 MDa (HPAM) to enable the display of elastic turbulence and xanthan as an additional thickening agent, and with a comparative solution containing only xanthan (which is too rigid to cause elastic turbulence, as mentioned above). These polymers do not form micelles but do cause birefringence when aligned. Flow rates and observations are given in the following table which also includes the comments from the above experiment with viscoelastic surfactant.

| Solutes | Flow rate | Comments concerning pictures |
|---|---|---|
| 4 wt % cetyl pyridinium | 5 ml/min | Red lines extending downstream from pillars do |
| chloride | | not change position. No changes in overall |
| 0.8 wt % sodium | | appearance |
| salicylate and | 25 ml/min | Red lines extending from pillars change angle |
| 0.6 wt % sodium | | relative to flow direction and change intensity. |
| chloride | | Green areas appear, change position and |
| | | disappear. |
| 0.25 wt % HPAM and | 5 ml/min | Red lines extending downstream from pillars do |
| 0.25 wt % xanthan | | not change position. Green areas do not change. |
| | 15 ml/min, | Movement of red areas extending downstream |
| | and 30 ml/min | from pillars, prominent green areas appear and |
| | | change position |
| 0.5 wt % xanthan | 5 ml/min, | Red and green areas do not change position at |
| | 30 ml/min and | any flow rate |
| | 40 ml/min | |
| 0.25 wt % xanthan | 30 ml/min | Red and green areas do not change position |
| 0.12 wt % HPAM, | 5 ml/min | Red and green areas do not change position |
| 0.12 wt % xanthan, and | 45 ml/min | Red and green areas change in shape and position |
| 0.465 wt % NaCl | | |

It is apparent from these comments that the solution containing HPAM and xanthan displayed elastic turbulence at 15 ml·sec and above, but solutions containing xanthan without HPAM did not display elastic turbulence even at 30 ml/min.

A further experiment demonstrated that elastic turbulence released bubbles from an electrode. As shown in FIG. 6, the chamber 20 was provided with a platinum wire electrode 45 projecting into space between two of the pillars of the flow guide and a small copper block 46 as a second electrode at the surface of the upper block 21. Electrical connection to the copper block 46 is indicated at 47. A power supply of about 2 volts was connected to the electrodes, with copper block 46 positive and wire 45 negative.

A solution containing 0.12 wt % HPAM of mean molecular weight 18 MDa, 0.12 wt % xanthan and 0.456 wt % sodium chloride was pumped through the flow guide 10 and the flow was observed using the apparatus as shown in FIG. 4. When the power supply was switched on, bubbles were seen in the flow downstream from the platinum wire electrode. The bubbles could be seen in the flow because they refract light out of the light path and so appear dark.

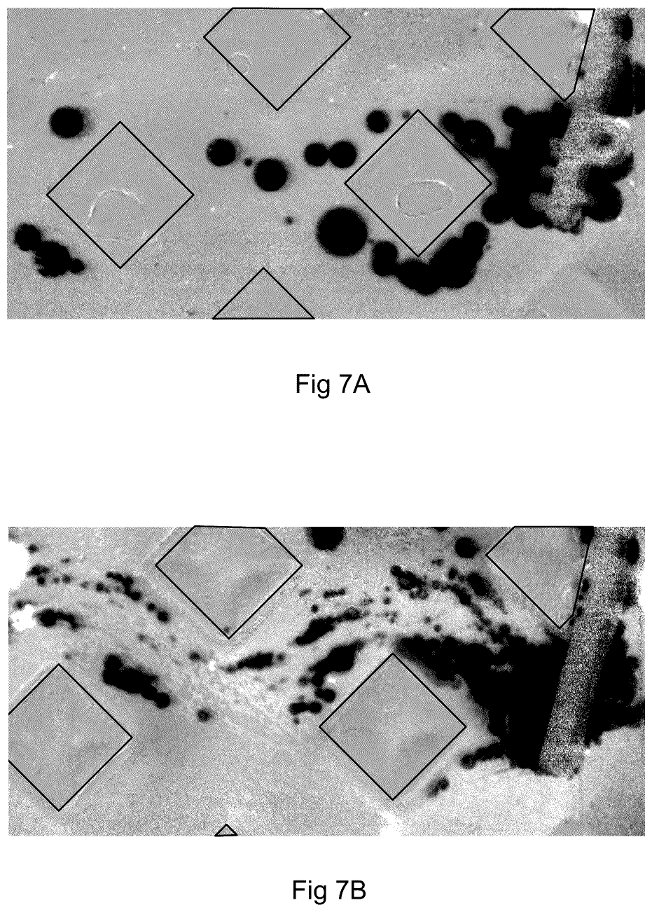

FIG. 7A is a picture of flow when the flow rate was 5 ml/min at which there is no elastic turbulence and FIG. 7B is a picture of flow when the flow rate was 45 ml/min at which elastic turbulence is present. The pictures were processed to show the bubbles in contrast with the remainder of the picture and squares have been drawn to show the edges of some pillars more clearly.

The diameters of the bubbles were estimated visually by comparison with the dimensions across and between the pillars. When the flow rate was 5 ml/min, which was too low to cause elastic turbulence, the bubbles had diameters in a range from approximately 0.2 to 0.5 mm but when the flow rate was increased to 45 ml/min at which elastic turbulence is present, the bubbles were clearly smaller and had diameters in a range from approximately 0.03 to 0.2 mm, showing that the elastic turbulence was dislodging the bubbles from the platinum wire electrode 45 before they had grown to the size at which bubbles left the electrode in the absence of elastic turbulence.

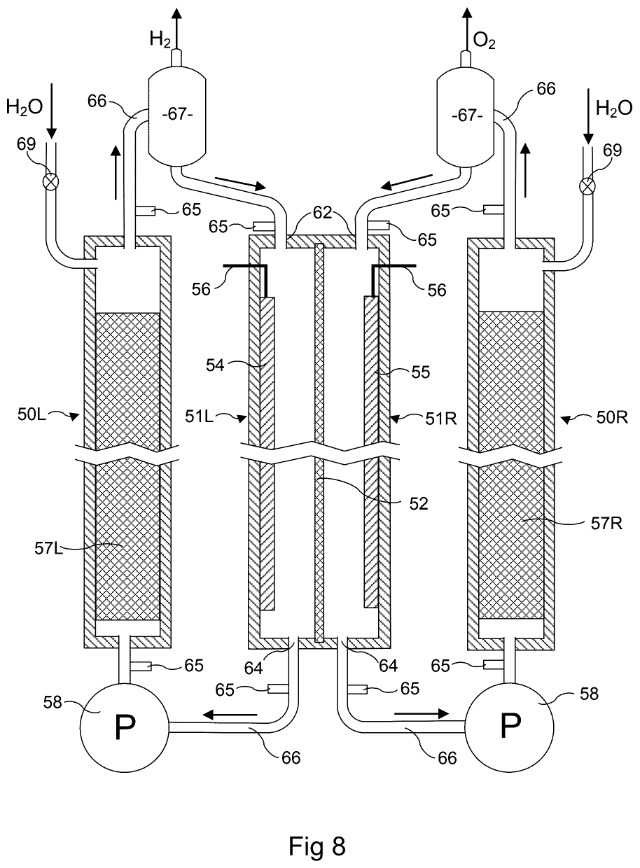

FIGS. 8 to 13 show various embodiments of apparatus for the production of hydrogen and oxygen in which one or more redox mediators are used. Each of these possible forms of apparatus includes an electrochemical cell with two half-cells each of which contains an electrode and two reaction chambers each connected to one of the half-cells. The half-cells are separated from each other by a separator with selective permeability. Hydrogen and oxygen are produced by reaction at catalysts in the reaction chambers. Porous materials, electrodes and catalysts used in these embodiments may be known materials. Published literature concerning such items includes Chen et al, “Key Components and Design Strategy for a Proton Exchange Membrane Water Electrolyzer”, Small Structures, Vol 4, 2200130 (2023) and Niblett et al., “Review of next generation hydrogen production from offshore wind using water electrolysis”, Journal of Power Sources, 592, 233904 (2024).

FIG. 8 shows apparatus with reaction chambers 50L and 50R connected to electrochemical half-cells 51L and 51R. These half-cells are separated by a selectively permeable membrane 52 which may be an ion exchange membrane. The half-cell 51L to the left of the separator 52 has a negative electrode 54. The half-cell 51R to the right has a positive electrode 55. Electrical connections to these electrodes are indicated at 56. Each half-cell has a top inlet 62 and a bottom outlet 64. Pressure sensors 65 are fitted near each inlet 62 and outlet 64.

The reaction chamber 50L includes a packing 57L of ceramic beads which include a catalyst or provides a support for a catalyst for the evolution of hydrogen. This reaction chamber 50L, the half-cell 51L, a pump 58 and the pipework 66 connecting them as a flow circuit contain a liquid which is an aqueous solution of a compound which acts as a redox mediator and also another solute which enables the solution to display elastic turbulence as it flows through the packing 57L. This liquid is the electrolyte for the half-cell 51L, and it is circulated by the pump 58 in the direction indicated by arrows. Pressure sensors 65 are fitted near to the inlets and outlets of the reaction chamber 50L and the half-cell 51L. In operation, hydrogen is formed in the reaction chamber 50L. It rises with the aqueous solution to a gas-liquid separator 67, from which the hydrogen flows upwards and the solution flows down into half-cell 51L. The reaction chamber 50R and the half-cell 51R have a similar layout. The packing 57R in the reaction chamber 50R consists of beads of a catalyst for the evolution of oxygen, or ceramic beads which are a support for such a catalyst. The liquid circulating through the reaction chamber 50R and half-cell 51R is again an aqueous solution of a compound which acts as a redox mediator. This solution also includes a solute which enables the solution to display elastic turbulence. Oxygen formed in the reaction chamber 50R is separated from the flow at a gas/liquid separator 67. Additional water, which may be deionized water, is supplied to each reaction chamber through valves 69 as required to replace water which has been converted to hydrogen and oxygen.

As described above, a solute which enables an electrolyte liquid to be in a state of elastic turbulence may be a long-chain linear polymer or may be a viscoelastic surfactant. The power and speed of the pumps 58 is chosen so as to propel each liquid at a flow speed where flow in the pipework 66 is laminar but as each liquid flows through a reaction chamber, the packing in that chamber compels the flow to curve and change direction repeatedly as was indicated by dashed lines in FIG. 3. The flow rate is sufficient that the liquid displays elastic turbulence within the reaction chamber. This causes gas bubbles forming on the catalyst or porous packing to detach while they are still at a smaller size than the size at which buoyancy would detach them in the absence of elastic turbulence. The elastic turbulence also enhances transport of redox mediator molecules to the catalyst from the bulk of the flowing liquid and back into the bulk after reaction.

One possibility for electrolyte liquids and catalysts for use in the apparatus shown in FIG. 8 is a system described by Amstutz et al., in “Renewable hydrogen generation from a dual circuit flow battery”, Energy and Environmental Science, Vol 7, Page 2350 (2014). The packing 57L in the half-cell 51L is ceramic beads with a surface coating of Mo₂C. The electrolyte liquid for the half-cell 51L and connected reaction chamber 50L is a 0.1M solution of VOSO₄ in 1M sulphuric acid. The vanadium ions are converted from V³⁺ to V²⁺ in the half-cell 51L and the hydrogen evolution reaction which takes place on the catalyst in the reaction chamber 50L is

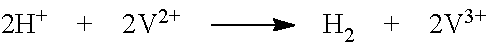

The electrolyte for the half-cell 51R and connected reaction chamber 50R is a 0.1M solution of cerium (III) sulphate in IM sulphuric acid. The cerium ions are converted from Ce³⁺ to Ce⁴⁺ in the reaction chamber 50R and back to Ce³⁺ in the half-cell 51R. The packing in the reaction chamber 57R is RuO₂ particles acting as catalyst. The oxygen evolution reaction in the chamber 50R is:

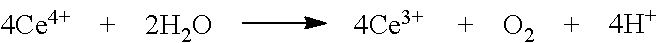

There is a flow of hydrogen ions from the half-cell 51R through the separator 52 to the half-cell 51L. The separator membrane 52 may be a Nafion membrane permeable to hydrogen ions.

A suitable concentration of a flexible long chain polymer to enable elastic turbulence to occur may be in a range from 0.1 to 2 wt %. A suitable concentration of a viscoelastic surfactant may be in a range from 1 to 10 wt %. Methods for determining flow rates and whether a polymer or surfactant concentration is sufficient to enable elastic turbulence are described below.

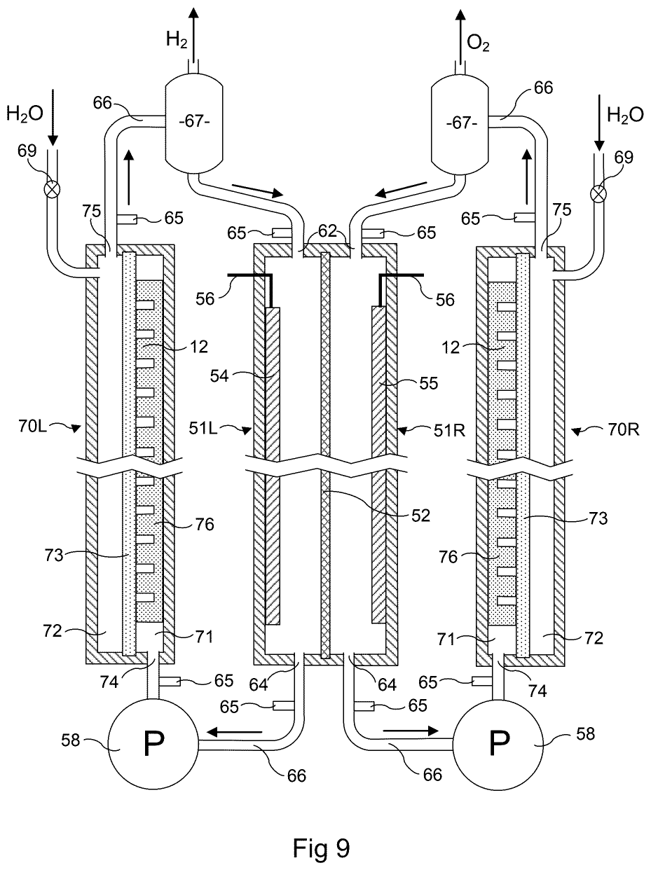

FIG. 9 shows apparatus which is largely similar to that in FIG. 8 but has reaction chambers 70L and 70R which each have two compartments 71, 72 with a block of porous material 73 between them. This porous material 73 acts as a catalyst support and also enables elastic turbulence to occur. The inlet 74 to each reaction chamber is at one side of the porous material 73 and the outlet 75 is at the opposite side. Liquid coming into the one of the reaction chambers initially flows beside the porous material 73 therein but must pass through it to reach the outlet 75 from the reaction chamber. On the inlet side of the porous material there is a flow guide 76 which is similar to the flow guide shown in FIG. 2 in that it has an array of spaced pillars 12 of square cross section integral with a base. However, this flow guide 76 has a longer and wider array of pillars 12 than are shown in FIG. 2. In use with a liquid containing a solute to cause elastic turbulence, pump 58 directs the liquid through the pipework 66 in a state of laminar flow but within the reaction vessel the flow guide 76 causes the flow to curve and make changes of direction repeatedly, as shown by broken lines in FIG. 3, so that elastic turbulence is caused in the liquid as it flows alongside and into the porous material 73.

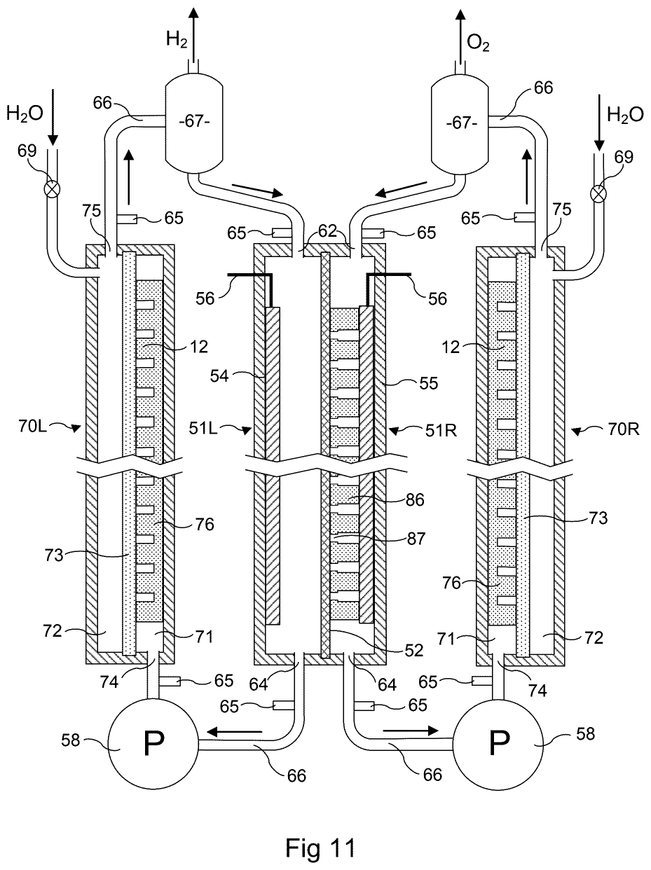

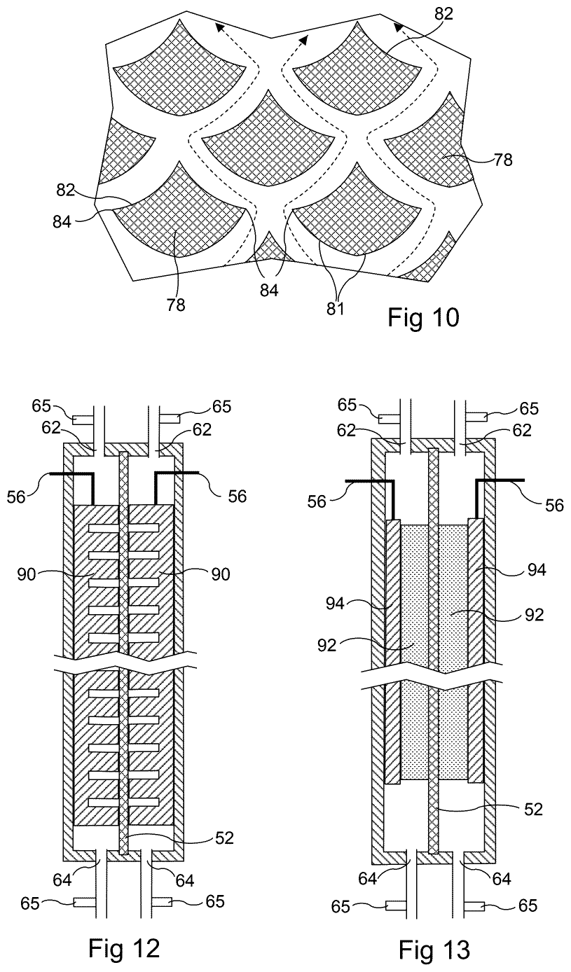

Pillars 12 of rectangular cross-section are one possibility for the flow guides 76 but other shapes of pillars can be used. This is illustrated by FIG. 10 which shows pillars 78 with another possible cross section. The surfaces 81 have convex curvature and intersect concave surfaces 82 at edges 84. Electrolyte liquid flows through the gaps between edges 84 as shown by broken lines and is compelled by the arrangement of pillars 78 to change direction at every gap between edges 84.

If the constructional arrangement of FIG. 9 is used with circulating liquids which are alkaline, the porous material 73 may be nickel foam. Reaction mediators for use in alkaline solutions can be water soluble organic compounds, including quinones, viologens and the radical TEMPO (2,2,6,6-tetramethyl-1-piperidinyloxyl). A system for splitting water using an organic redox mediator, which may be used in the apparatus of FIG. 9, has been described by F. Zhang et al. in “Decoupled redox catalytic hydrogen production with a robust electrolyte-borne electron and proton carrier” J. Am. Chem. Soc. Vol 143, Page 223 (2021). Using this system, the electrolyte liquid in the half-cell 51L and connected reaction chamber 70L is a 0.6M solution of 7,8-dihydroxyphenazine-2-sulphonic acid in 4M sodium hydroxide solution. The catalyst used in the reaction chamber 70L is platinum in the form of platinum particles supported on a nickel foam substrate as described in the Supporting Information accompanying the above F. Zhang et al. article. The electrochemical reaction in the half-cell 51L is:

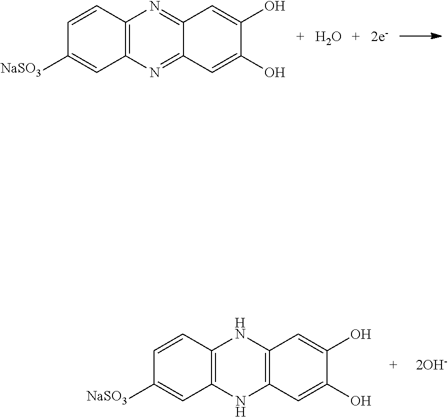

and the reaction at the platinum catalyst in the chamber 70L is:

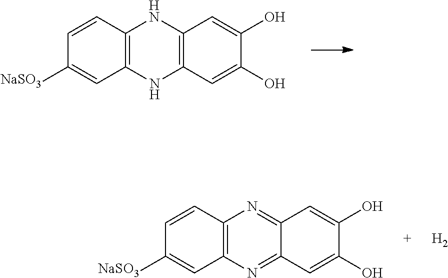

The separator membrane between the half-cells is chosen to be permeable to hydroxyl ions.

Electrolyte liquid for the half-cell 51R and reaction chamber 50R is 0.6M potassium ferricyanide in 4M solution sodium hydroxide solution and the catalyst is iron-doped nickel hydroxide formed on the nickel foam as also described in the Supporting Information of the above F. Zhang et al article. The electrochemical reaction in the half-cell 51R is:

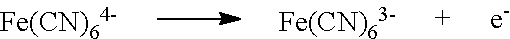

and the reaction in the chamber 70R is:

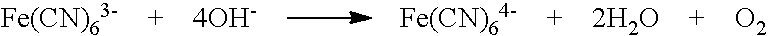

In both half-cells the elastic turbulence causes gas bubbles to detach from the catalyst and also the porous nickel foam before the bubbles grow to the size at which buoyancy would detach them, thus keeping more of the catalyst available for reaction. It also improves transport of redox mediator to the catalyst surfaces and away from the catalyst surfaces after reaction, thereby reducing overpotential.

FIGS. 8 and 9 show embodiments in which elastic turbulence is used in the reaction chambers but not in the half-cells. Elastic turbulence may also be used in the electrochemical half-cells. FIG. 11 shows an electrochemical cell which is constructed similarly to the cell shown in FIG. 9 except that the half-cell 51R contains a flow guide 86. This flow guide is generally similar to the flow guides 76 in the reaction chambers, except that the base of the flow guide 86 has holes 87 through it at positions between pillars 12 in order to allow passage of the ions which pass through the separator membrane 52. The flow guides 72 may be made of electrically non-conductive material. The flow rate of the circulating liquid within half-cell 51R and the presence of the long chain polymer or viscoelastic surfactant in the liquid enables elastic turbulence to occur as the liquid passes through the flow guide 86 alongside the electrode, thereby enhancing the movement of redox mediator molecules from the flowing solution to and from the surface of the electrode. Elastic turbulence also occurs as the circulating liquid passes through the reaction chamber 70R, as in the embodiment of FIG. 9.

A system as shown in FIG. 9 or FIG. 11 could be used with seawater as the water supply. As disclosed by Liu et al. in “Redox-mediated decoupled seawater direct splitting for H₂ production” Nature Communications, Vol 15, Article 8874, (2024), a system using the ferrocyanide/ferricyanide couple as redox mediator requires a redox potential of smaller magnitude than is required for oxygen formation at the electrode and this avoids the unwanted chlorine electrooxidation reaction which can damage the electrode.

FIGS. 12 and 13 show two further possibilities for an electrochemical cell which is connected to reaction chambers in the manner shown by FIGS. 8 and 9. In these FIGS. 12 and 13, elastic turbulence is made to occur in the half-cells as well as in the reaction chambers. In FIG. 12, each half-cell contains a flow guide 90 which comprises an array of pillars on a base, as illustrated by FIG. 3, but each flow guide 90 is made of an electrically conductive material or has an electrically conductive surface coating and it serves as an electrode as well as causing repeated changes to the direction of flow and so causing elastic turbulence to occur.

In FIG. 13 each half-cell contains a pad 92 of carbon fibers which provide a network of interconnected small channels which cause through flow to make repeated changes of flow direction and so enable elastic turbulence to occur. Because these pads are made of carbon fibers, they are electrically conductive. They are in contact with metallic parts 94 which carry electric current to the fibers of the pads 92, and so these pads enable elastic turbulence and also serve as electrodes for electrochemical reaction of the redox mediators to take place at the fiber surfaces.

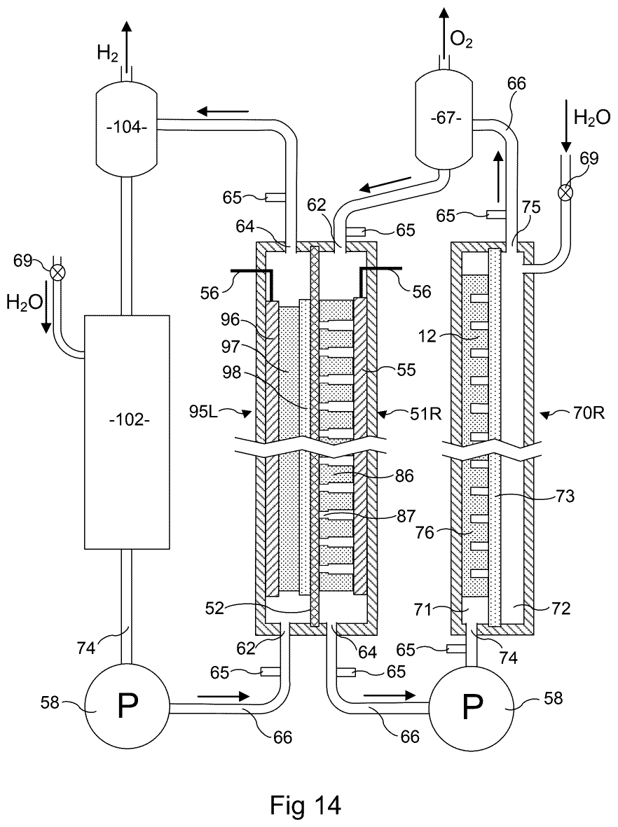

The embodiments shown in FIGS. 8 to 13 and described above all split water into hydrogen and oxygen. Consequently, the amounts of hydrogen and oxygen produced match the composition of water. Although the embodiments shown above all use elastic turbulence to improve mass transport and improve the release of both hydrogen and oxygen bubbles, the rates of individual reactions may be such that it is not necessary to use elastic turbulence equally for the evolution of both gases. FIG. 11 has already shown apparatus in which elastic turbulence is used in both reaction chambers but only one of the half-cells. FIG. 14 shows an example embodiment in which a redox mediator is used for evolution of oxygen but not for evolution of hydrogen. Evolution of oxygen is carried out using elastic turbulence in half-cell 51R and reaction chamber 70R as described above.

For evolution of hydrogen, the half-cell 95L is connected in a circuit which also includes a liquid supply tank 102, a gas liquid separator 104 and a pump 58 which circulates an electrolyte liquid from the tank 102 to inlet 62 at the lower end of half-cell 95L. The liquid flows upwards through the half-cell to its outlet 64 from where it flows to the gas-liquid separator 104 which allows hydrogen gas to flow out upwardly and the liquid to flow down into tank 102. The half-cell contains an electrode assembly comprising a metal sheet or grid 96 as a current carrier and porous material 97 which is also electrically conductive. The porous material 97 may be carbon felt. A layer 98 which is positioned next to the separator membrane 52 is a porous material with a catalyst for the formation of hydrogen deposited on it.

The electrolyte liquid in the tank 102 and half-cell 95L contains polymer or surfactant able to cause the liquid to display elastic turbulence and is pumped with sufficient speed to induce such turbulence in the half-cell 95L. The turbulence will be present in the layer 97 and will also be present in the adjacent catalyst layer 98 because the porous structure of these layers causes the flow within them to make repeated changes of direction and/or because turbulence in the layer 97 extends into the adjacent layer 98. The elastic turbulence dislodges hydrogen bubbles from the layers 98 and 97 before these bubbles grow to the size at which they would be dislodged by buoyancy.

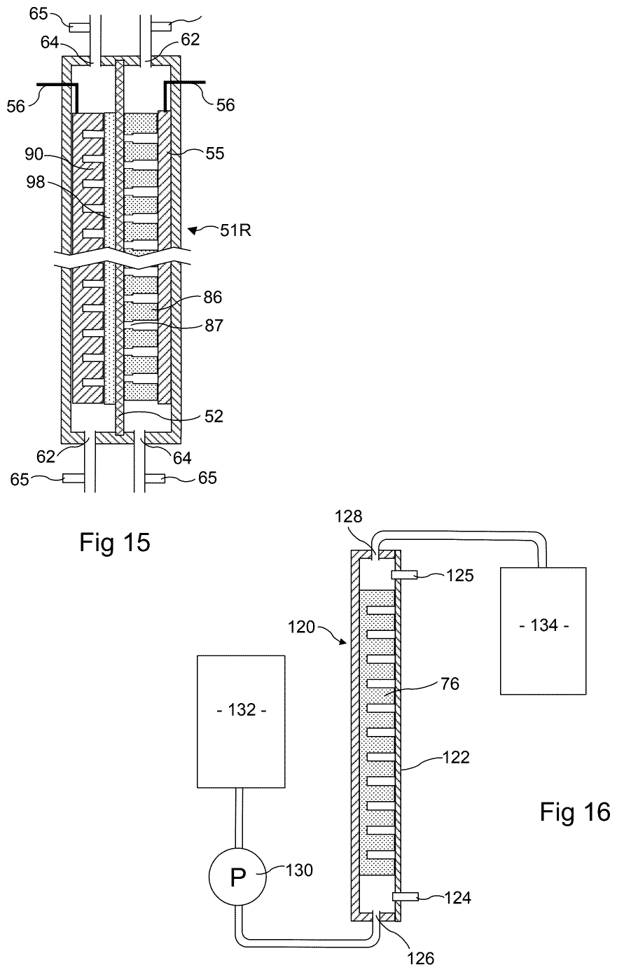

FIG. 15 shows another electrolytic cell which could be used in the apparatus of FIG. 14. It differs from the cell shown in FIG. 14 in that the current carrier 96 and porous material 97 are replaced with a flow guide 86 made of an electrically conductive material or having an electrically conductive surface coating. In use, elastic turbulence will dislodge hydrogen bubbles from the catalyst layer 98.

For reaction chambers and electrochemical half-cells as described above, with a polymer or surfactant present in a circulating liquid, a flow rate which is sufficient to cause elastic turbulence to occur may be found by monitoring electric current while progressively increasing the flow rate. When elastic turbulence begins the improved release of gases from surfaces will be apparent as an increase in the flow of electric current.

However, it is also possible to determine a suitable flow rate without operation of complete apparatus, which may be useful at a design stage. This is illustrated by FIGS. 16 to 18. As shown in FIG. 16, a structure 120 with the dimensions of a proposed reaction chamber includes a proposed flow guide 76 of the type which was shown in FIGS. 9 and 11 and which has pillars 12 projecting from a base, as shown in FIG. 2. No separator or membrane is present. Instead, a plate 122 is fitted against the tops of the pillars 12 of the flow guide 76. Pressure sensors 124, 125 are fitted at the inlet and outlet regions of the structure 120. The inlet 126 is connected to a pump 130 which delivers fluid from a tank 132 which is maintained at a fixed temperature. This fluid should be the same as the fluid which will flow through the proposed reaction chamber or half-cell. The outlet 128 of the structure 120 is connected to a graduated vessel 134 for measuring volume of liquid which has been pumped through the flow guide 76 in a chosen interval of time and thereby determining the flow rate.

When liquid from the tank 132 is pumped through the structure 120 containing flow guide 76 there will be a pressure drop between the inlet pressure sensor 124 and the outlet pressure sensor 125. When the flow rate is very low, the flow will be laminar, without any elastic turbulence. The minimum flow rate to cause elastic turbulence in the flow guide 76 can be found by progressively increasing the pump speed to increase the flow rate and plotting the pump speed, which increases with pressure drop, against flow rate. This plot will show a change in slope on reaching the flow rate at which elastic turbulence begins.

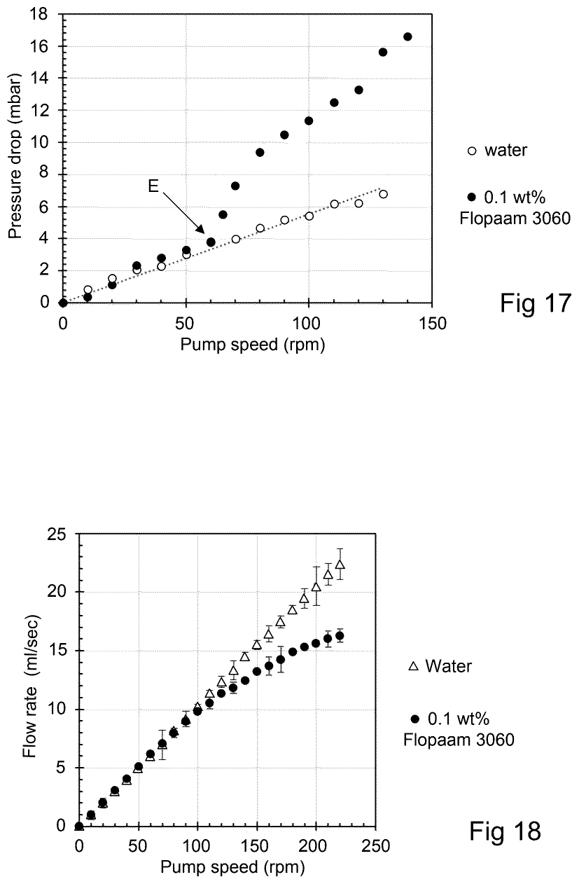

This is illustrated by the following description of experimental work with apparatus similar to that shown. The results of the experiments are shown in FIGS. 17 and 18. An initial calibration determines relationships between pump speed and flow rate. The tank 132 was filled with water. The pump 130 was used to propel water through the structure 120 containing flow guide 72 at progressively increasing flow rate. The pump speeds and the flow rates measured downstream of the structure 120 were recorded and are shown in FIG. 18 (triangle points). This calibration procedure was then repeated with an aqueous solution containing 0.1 wt % of Flopaam 3630 polyacrylamide dissolved in the liquid in the tank 132. This gave the non-linear plot also shown in FIG. 17 (circular points).

FIG. 18 shows the measured flow rate plotted against pump speed. With water the plot was approximately linear (as would be expected because water is a Newtonian fluid) but with the polyacrylamide solution there was a very sharp change in the slope of the plot at the point E, indicating that the flow rate at this point was the minimum required to cause elastic turbulence with that polyacrylamide solution and apparatus.

Measurements of this kind make it possible to estimate Reynolds number for flow through a flow guide 76. The formula which may be used to determine Reynolds number (Re) for flow through a chamber containing obstructions so as to compel the flow streamlines to bend is:

$$R e = \frac{ρ U L}{η}$$

where p is density of the fluid in Kg per cubic metre,
U is the flow velocity in metres per second,
L is the width of the gaps between the obstructions in the chamber, and
η is the viscosity of the fluid in Pascal·sec.

If the flow rate is measured as volume in unit time, the formula above becomes:

$$R e = \frac{ρ QL}{η A}$$

where Q is the flow rate in cubic metres per second and A is the cross-sectional area, transverse to the overall direction of flow, through which the flow passes.

In an example of the flow guide shown in FIGS. 7, 11 and 14, the flat faces 12 of the pillars had a width “a” of 4 mm and the height of the pillars was 7 mm. The spacing “b” between the faces 16 of adjacent pillars was 2 mm and so the gaps between adjacent edges 18 was √8=2.83 mm. A full line of pillars transverse to the overall direction of flow contained 12 pillars with 11 gaps between edges 44, and so the cross section available for flow was:

$$11 \times 7 \times 2.83 {mm}^{2} = 11 \times 7 \cdot {10}^{- 3} \times 2.83 \cdot {10}^{- 3} {m}^{2} .$$

Flow rate was measured as 75 ml·sec⁻¹=7.5×10⁵ m³ sec⁻¹. Density of the fluid was 1000 kg/m³; viscosity was 0.008 Pa·sec. Putting these numbers into the formula mentioned above:

$$Re = \frac{ρ QL}{η A} = \frac{1000 \times 7.5 \cdot {10}^{- 5} \times 2.83 \cdot {10}^{- 3}}{8 \cdot {10}^{- 3} \times 11 \times 7 \cdot {10}^{- 3} \times 2.83 \cdot {10}^{- 3}}$$

which is Re=12.17.

The methods and apparatus of the present disclosure can be used for other processes in which gases are formed by electrochemical reaction.

Various embodiments of this disclosure have been set out above. These are intended to assist understanding of this disclosure, but not to limit it in any way. It should be appreciated that any features or possibilities described in combination may, where it is practical to do so, be used individually. Also, features or possibilities mentioned in the following claims or described in any embodiment may be used in any other embodiment, in so far as it is practical to do so and where two or more of the following claims are dependent on the same preceding claim, the reader should understand that the present disclosure includes any possible combination of any two or more or all of those dependent claims with each other and also with that preceding claim.

1. A system comprising:
a reaction chamber, an electrochemical cell comprising first and second half-cells each comprising an electrode, at least one pump, and connections between the pump, the reaction chamber and the first half-cell providing a first flow circuit for the pump to circulate a liquid through the reaction chamber, from the reaction chamber to the first half-cell, through the first half-cell and back to the reaction chamber;
wherein:
the first half-cell defines a flow path to carry through flow of the liquid into contact with the electrode;
the reaction chamber includes a reaction catalyst, and the reaction chamber defines a flow path to carry through flow of the liquid into contact with the catalyst, the liquid is able to undergo reaction at the catalyst to form a gas;
an electrochemically reactive mediator substance is dissolved in the liquid, the mediator substance being able to undergo an electrochemical conversion between a first state and a second state at the electrode;
wherein the mediator substance and the liquid are such that when electric current is supplied to the electrode while the pump is circulating the liquid, the mediator substance is converted from its first state to its second state at the electrode, reaction at the catalyst in the reaction chamber forms gas from the liquid and returns the mediator substance to its first state;
and further wherein:
the liquid further contains a solute enabling the liquid to display elastic turbulence, and the flow path in the reaction chamber is configured to compel changes in the direction of liquid flow, to cause elastic turbulence within flow of the liquid in contact with the catalyst.

2. The system of claim 1, wherein the reaction chamber comprises a bed of particulate material which is the catalyst or which supports the catalyst, the flow path in the reaction chamber extends through the bed wherein the particulate material compels changes in the direction of liquid flow.

3. The system of claim 1, wherein the reaction chamber comprises a flow guide formed of solid material and defining a flow path which includes obstructions which compel changes in the direction of liquid flow.

4. The system of claim 3, wherein the flow path through the reaction chamber extends beside porous material which supports the catalyst.

5. The system of claim 1, wherein the flow path in the first half-cell is configured to compel changes in the direction of liquid flow, to cause elastic turbulence within flow of the liquid in contact with the electrode of the first half-cell.

6. The system of claim 1, wherein the solute enabling the liquid to display elastic turbulence is a viscoelastic surfactant which forms wormlike micelles.

7. The system of claim 1, wherein the solute enabling the liquid to display elastic turbulence is a linear polymer with a molecular weight of at least 106 Daltons.

8. The system of claim 1, wherein the solute enabling the liquid to display elastic turbulence is a polymer containing at least 5,000 monomer units in one or more linear polymer chains each containing at least 1,000 monomer units, connected one to the next by a single covalent bond so that one monomer unit can rotate relative to adjoining monomer units.

9. The system of claim 8, wherein the polymer is a polyacrylamide or hydrolysed polyacrylamide.

10. The system of claim 1, wherein reaction in the reaction chamber forms oxygen gas.

11. A system comprising:
first and second reaction chambers, an electrochemical cell comprising first and second half-cells each comprising an electrode, first and second pumps, connections between the first pump, the first reaction chamber and the first half-cell providing a first flow circuit for the first pump to circulate a first liquid through the first reaction chamber, from the first reaction chamber to the first half-cell, through the first half-cell and back to the first reaction chamber, and connections between the second pump, the second reaction chamber and the second half-cell providing a second flow circuit for the second pump to circulate a second liquid through the second reaction chamber, from the second reaction chamber to the second half-cell, through the second half-cell and back to the second reaction chamber;
wherein in each flow circuit, the half-cell defines a flow path to carry through flow of the liquid into contact with the electrode therein;
the reaction chamber comprises a reaction catalyst, and the reaction chamber defines a flow path to carry through flow of liquid into contact with the catalyst;
the liquid flowing through each reaction chamber is able to undergo reaction at the catalyst therein to form a gas;
an electrochemically reactive mediator substance is dissolved in the liquid, the mediator substance being able to undergo an electrochemical conversion between a first state and a second state at the electrode;
wherein the mediator substance and the liquid are such that when electric current is supplied to the electrode while the pump is circulating the liquid, the mediator substance is converted from its first state to its second state at the electrode;
reaction at the catalyst in the reaction chamber forms gas from the liquid and returns the mediator substance to its first state;
and further wherein the first and second liquids each contain a solute enabling the liquid to display elastic turbulence, and the flow path in the reaction chamber of each flow circuit is configured to compel changes in the direction of liquid flow, to cause elastic turbulence within flow of the liquid in contact with the catalyst.

12. The system of claim 11, wherein reaction in the first reaction chamber forms oxygen gas and reaction in the second reaction chamber forms hydrogen gas.

13. The system of claim 12, which is a system for converting seawater to oxygen gas and hydrogen gas.

14. The system of claim 11, wherein at least one reaction chamber comprises a bed of particulate material which is the catalyst or which supports the catalyst and the flow path in the reaction chamber extends through the bed wherein the particulate material compels changes in the direction of liquid flow.

15. The system of claim 11, wherein at least one reaction chamber comprises a flow guide formed of solid material and defining a flow path which includes obstructions which compel changes in the direction of liquid flow and wherein the flow path through the reaction chamber extends beside porous material which supports the catalyst.

16. The system of claim 11, wherein the solute enabling the first, the second or both liquids to display elastic turbulence is a viscoelastic surfactant which forms wormlike micelles.

17. The system of claim 11, wherein the solute enabling the first, the second or both liquids to display elastic turbulence is a linear polymer with a molecular weight of at least 106 Daltons.

18. The system of claim 11, wherein the solute enabling the first, the second or both liquids to display clastic turbulence is a polymer containing at least 5,000 monomer units in one or more linear polymer chains each containing at least 1,000 monomer units, connected one to the next by a single covalent bond so that one monomer unit can rotate relative to adjoining monomer units.

19. The system of claim 18, wherein the polymer is a polyacrylamide or hydrolysed polyacrylamide.

20. The system of claim 11, wherein the liquid in the flow circuit or each of the first and second liquids in the first and second flow circuits is an acidic aqueous solution and the first and second half-cells have a proton exchange membrane between them allowing passage of hydrogen ions through the membrane from one half-cell to the other.

21. The system of claim 11, wherein the liquid in the flow circuit or each of the first and second liquids in the first and second flow circuits is an alkaline aqueous solution and the first and second half-cells have a separator between them allowing passage of hydroxyl ions through the separator from one half-cell to the other.

22. A process for the production of a gas comprising operating a system according to claim 1, by pumping the liquid around the flow circuit and applying electrical potential to the electrodes.

23. A process for the production of two gases comprising operating a system according to claim 11, by pumping the first and second liquids around the first and second flow circuits respectively and applying electrical potential to the electrodes.
